(19) United States
(12) Patent Application Publication
(10) Pub. No.: US 2012/0045578 A1
(43) Pub. Date: Feb. 23, 2012

(54) METHOD FOR MANUFACTURING A PHOTONIC CRYSTAL DEVICE PROVIDED WITH A PLASMONIC WAVEGUIDE

(75) Inventors: Enzo Mario Di Fabrizio, Roma (IT); Francesco De Angelis, Roma (IT); Gobind Das, Catanzaro (IT); Federico Mecarini, Viterbo (IT); Patrizio Candeloro, Pescara (IT); Carlo Liberale, Casteggio (Pavia) (IT)

(73) Assignee: CALMED S.r.l., Catanzaro (IT)

(21) Appl. No.: 13/120,134

(22) PCT Filed: Sep. 22, 2009
(86) PCT No.: PCT/IB2009/054143

§ 371 Date: Nov. 7, 2011

(30) Foreign Application Priority Data
Sep. 23, 2008 (IT) TO2008A000693

(51) Int. Cl. G02B 6/124

(52) U.S. Cl. 427/163.2

(57) ABSTRACT

A method for manufacturing a photonic crystal device provided with a plasmonic waveguide includes: preparing a membrane; applying, in a programmed manner, a focused ion beam on the membrane, in a manner such as to obtain a photonic crystal made up by a regular planar arrangement of through holes positioned according to a preset lattice and also comprising a resonant cavity. The method also provides a conic plasmonic waveguide at the resonant cavity, through chemical vapour deposition induced by a focused electron beam. The focused electron beam that induces la deposition is controlled in such a manner to gradually reduce the transverse section of the electron beam starting from the base up to the tip of the projecting structure, maintaining the position of the electron beam constant.

The present invention refers to a method for manufacturing of a photonic crystal device provided with a plasmonic waveguide, comprising the following steps
preparing a membrane of dielectric material;
applying, in a programmed manner, a focused ion beam on the membrane, in a manner such as to obtain a photonic crystal made up by a regular planar arrangement of through holes positioned according to a predefined lattice, said photonic crystal further comprising a resonant cavity, made up of a spatially confined region of the lattice inside which said through holes are absent, said resonant cavity being dimensioned in a manner such as to be in resonance with at least one electromagnetic radiation wavelength; and
providing a plasmonic waveguide at said resonant cavity, in which providing the plasmonic waveguide comprises the following steps:
   a) growing a projecting structure on the resonant cavity through chemical vapour deposition induced by a focused electron beam, starting from a metal-organic precursor gas;
   b) depositing a noble metal layer; and
   c) selectively removing the noble metal deposited outside the projecting structure by means of a focused ion beam.

The inventors have recently made a similar type of hybrid plasmonic-photonic nanodevice, which has also been described in a scientific publication (F. De Angelis, M. Patrini, G. Das, I. Maksymov, M. Galli, L. Businaro, L. C. Andreani, and E. Di Fabrizio, “A Hybrid Plasmonic-Photonic Nanodevice for Label-Free Detection of a Few Molecules”, Nano Letters, 17 Jul. 2008, online edition). The device described is conceived to detect a few molecules in a far field configuration by means of a Raman spectroscopy. The operation principle of the device combines the characteristics of light concentration of a dielectric photonic crystal cavity with the confinement properties of a metal nano waveguide. The operation principle of the device is based upon the fact that by illuminating the cavity with a laser beam in the visible region, a surface plasmonic electromagnetic field is generated that propagates from the cavity towards the end of the tip of the nanoguide. The device is designed in a manner such as to obtain a concentration of the electric field of the incident laser, only around the end of the plasmonic guide, for a spatial region comparable to the radius of curvature of the tip (less than 10 nm). An electric field thus located becomes extremely useful to electrically excite the molecules of any material in the immediate vicinity. In such a way by collecting the reemitting signal of the molecules/atoms of the material, it is possible to carry out a spectroscopy with a spatial resolution comparable to the radius of curvature of the plasmonic guide. The spectroscopies that can be carried out are in particular the fluorescence spectroscopy and the Raman spectroscopy.

The range of possible applications for the device is not however limited to optical spectroscopy. For example, the field concentration obtained could also be used to carry out optical nanolithography with a spatial resolution much lower than the wavelength of the laser λ (about λ/100) Or, such a field concentration could be used to excite second and third harmonic radiation in non linear optical systems. Another application could be that of exciting the emission of a single photon from a quantum dot near to the tip of the nanoguide.

The manufacturing of the device described in the aforementioned publication foresees the production of the photonic crystal through erosion with a focused ion beam (FIB). The photonic crystal is made up of a membrane of Si₃N₄ with a triangular lattice of holes. The cavity is of the L3 type and it is made up by three missing holes at the centre of the area of the crystal and along the direction Γ-K.

In a second step, at the centre of the cavity, a platinum nanoantenna is deposited, exploiting the chemical vapour deposition (CVD) induced by a focused electron beam starting from a precursor gas of (CH₃)₃Pt(CₚCH₃). After the growth of the nanoantenna on the sample a thin film of gold is deposited, which is then removed from the photonic crystal (but not from the nanoantenna) through erosion with a focused ion beam.

The nanoantenna of the device described in the article has a bar shape, with an ogival shaped tip. The geometry of the nanoantenna plays an important role in defining the details of the profiles of the surface plasmon polariton modes (indicated hereafter with SPP). The inventors have verified that the SPP mode is highly localised in a region comparable to the radius of curvature of the tip, providing an efficient coupling for far field scattering events.

In the aforementioned work it is also indicated that an adiabatic behaviour can be foreseen in the case in which the nanoantenna is perfectly conical shaped.

The purpose of the present invention is that of proposing a method for manufacturing a photonic crystal device provided with a plasmonic waveguide having a conical shape.

This and other purposes are obtained with a method of the type defined at the beginning, in which
in step a) of the manufacturing of the plasmonic waveguide, the focused electron beam that induces the deposition is controlled in a manner such as to gradually reduce the transverse section of said electron beam starting from a first base layer of the projecting structure deposited on the membrane up to a final tip layer of the projecting structure, maintaining the position of the electron beam constant.

The method according to the invention allows a conical waveguide to be provided having a highly regular profile, which allows to obtain a substantially adiabatic behaviour and thus high amplification factors of the electric field at the tip of the antenna.

Particular embodiments form the object of the dependent claims, whose content is to be understood as integrating part of the present description.

Further characteristics and advantages of the invention shall become clear from the following detailed description, given purely as a non-limiting example, with reference to the attached drawings, in which:

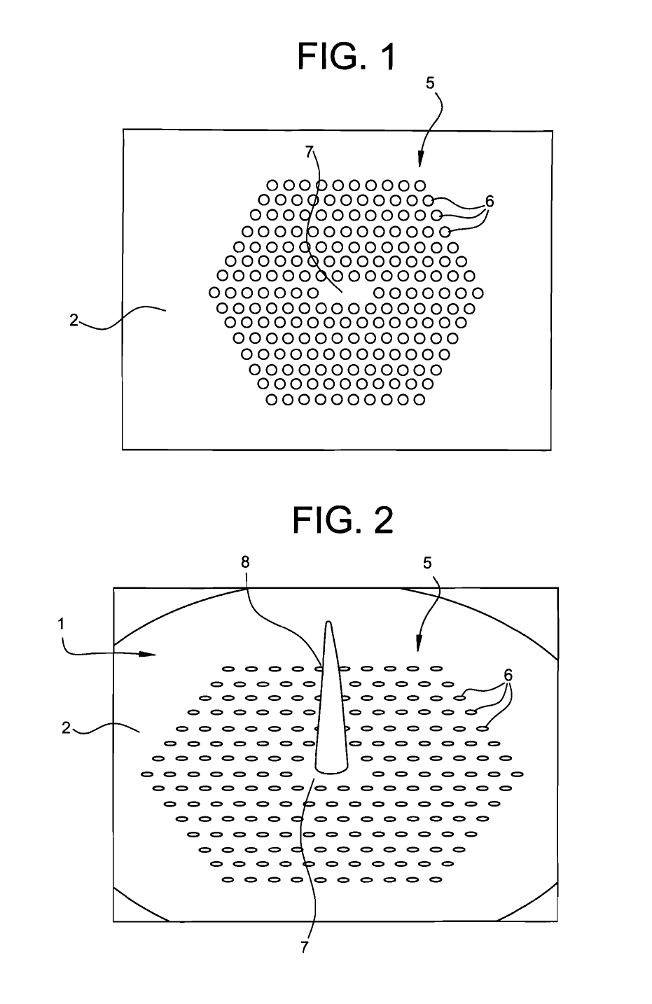

FIG. 1 represents the layout of a photonic crystal;

FIG. 2 is a perspective view of a photonic crystal device provided with a conical plasmonic waveguide; and

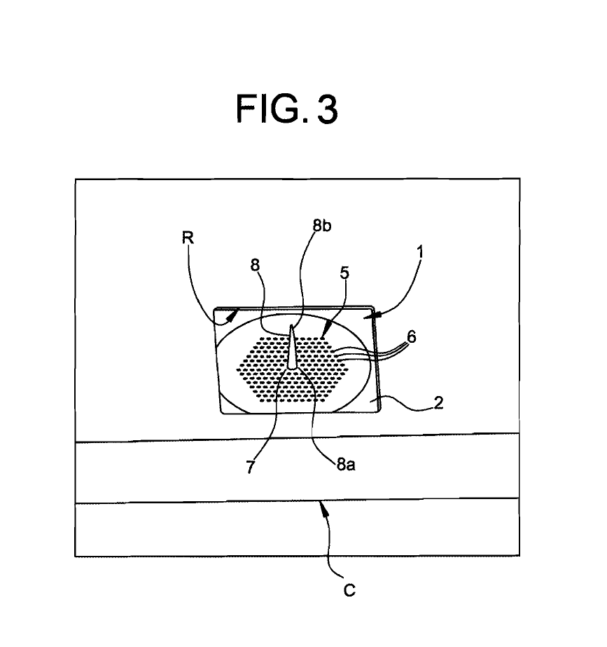

FIG. 3 is a perspective view of a detail of a cantilever of an atomic force microscope provided with the device of FIG. 2.

A method for manufacturing a photonic crystal device provided with a plasmonic waveguide shall now be described. Such a method according to the invention allows to obtain a photonic device with a conical waveguide, like the one represented in FIGS. 2 and 3.

The device, wholly indicated with reference numeral 1, comprises a substrate made up by a membrane 2 of dielectric material, for example silicon nitride. The thickness of the membrane 2 must be such as to allow the holes of the photonic crystal to be precisely obtained, by means of a focused ion beam (FIB). Such a membrane, for example, can have a thickness of the order of 100 nm.

On the membrane 2 a photonic crystal is obtained, wholly indicated with reference numeral 5. Conventionally, the photonic crystal 5 is made up by a regular planar arrangement of through holes 6 positioned according to a preset lattice. In the example illustrated, it is a triangular lattice, as clearly shown in FIG. 1; the holes 6 have a diameter of the order of 100 nm, whereas the pitch of the lattice is around double the diameter of the holes.

The photonic crystal 5 also comprises a resonant cavity 7, formed by a spatially confined region of the lattice 5 inside of which the through holes are absent. The resonant cavity 7 is dimensioned in a manner such as to be in resonance with at least one electromagnetic radiation wavelength. In the example illustrated, the cavity 7 is an L3 type cavity, formed by three missing holes at the centre of the lattice 5 and along the direction Γ-K.

At the centre of the cavity 7 a plasmonic waveguide 8 is made, having a conical shape and substantially projecting out perpendicularly with respect to the plane of the photonic crystal 5. The base 8a of the cone has a diameter of the order of 200 nm, whereas the tip 8b has a diameter of the order of 1 nm. The length of the guide 8 is however, of the order of 1 μm. On the entire surface of the waveguide 8 there is a thin film of noble metal (with a thickness of the order of 10 nm), such as gold or silver.

The method for manufacturing the device initially foresees preparing the substrate, and thus the membrane 2. Before applying the focused ion beam to obtain the photonic crystal 5, the membrane 2 is coated with a metal film (with a thickness of the order of 10 nm) through sputtering. This deposition is used to avoid electrically charging the membrane 2 which would otherwise be caused by the subsequent ionic and electronic bombardment, since the material of the membrane is an insulating material.

After preparing the membrane 2, a focused ion beam is applied in a programmed manner, such as to obtain the photonic crystal 5 comprising the resonant cavity 7.

Thereafter, the plasmonic waveguide 8 is made at the resonant cavity 7. The manufacture of the plasmonic waveguide 8 comprises the following steps:
a) growing a projecting structure on the resonant cavity 7 through chemical vapour deposition (CVD) induced by a focused electron beam, starting from a metal-organic precursor gas, preferably a platinum-based precursor gas;
b) depositing a layer of noble metal; and
c) selectively removing the noble metal deposited outside the projecting structure by means of a focused ion beam.

In step a) the precursor gas used for manufacturing the plasmonic waveguide is, for example, (CH₃)₃Pt(CₚCH₃). During such a step, the focused electron beam that induces the deposition is controlled in a manner such as to gradually reduce the transverse section of the electron beam starting from a first base layer 8a of the projecting structure deposited on the membrane 2 up to a final tip layer 8b of the projecting structure, maintaining the position of the electron beam constant. In this way the conical shape of the waveguide is defined. Making the waveguide through electron beam induced CVD allows a highly precise profile to be obtained for the guide, since it substantially allows the section of the guide to be controlled layer by layer, by simply modifying the section of the electron beam. In particular, the inventors have made a conical waveguide through the consecutive etching (with still beam) of a plurality of concentric circles with a decreasing diameter, for example 30 circles with a decreasing diameter from 250 nm to 1 nm, with a reduction step of the diameter of 10 nm. The electron beam thus carries out an etching strategy defined by a predetermined trajectory, in particular a trajectory of concentric circles.

The noble metal used in step b) for providing the plasmonic waveguide can be gold or silver, and is deposited through sputtering or evaporation. The thin film thus obtained has a thickness of the order of 10 nm. Preferably, the noble metal layer is bimetallic, comprising a lower layer of silver and an upper golden layer. This provision increases the efficiency in the concentration of the electrical field on the tip of the waveguide since, with the gold coating, the oxidation of the underlying silver is avoided.

The step c) of removing the noble metal is performed using an ion beam having a circular crown section, centred on the waveguide and having an inner diameter which is greater than the diameter of the base of the waveguide. In this way it is possible to remove the noble metal deposited on the membrane without touching that present on the waveguide.

The ions possibly implanted in the material of the device (at a depth lower than 10 nm), after applying the ion beam, are conventionally removed through liquid attack.

The device according to the invention can be incorporated in a cantilever of an atomic force microscope (AFM), as illustrated in FIG. 3. In such a figure a portion of the cantilever is visible, indicated with C, in which an indentation R has been formed, by means of a focused ion beam. The device 1 according to the invention is made inside the indentation R. In order to make the device 1 it is indeed necessary to locally thin out the cantilever C (which normally has a thickness of the order of 1 μm) such as to obtain a thickness which is thin enough as to be used as the membrane of the device 1. By adding the device 1 on the cantilever it becomes possible to combine atomic force measurements with chemical measurements made by the spectroscopes which can be carried out with the device. Therefore, it is possible to have a chemical and topographical mapping of biological material, and/or solid material in general, with spatial resolutions less than 10 nm, in simultaneous combination with the force spectroscopy which can be obtained with AFM.

Of course, without affecting the principle of the invention, the embodiments and the details of the invention can be widely varied with respect to what has been described and illustrated purely as an example and not for limiting purposes, without for this reason departing from the scope of protection of the present invention defined in the attached claims.

1. A method for manufacturing a photonic crystal device provided with a plasmonic waveguide, said method comprising the following steps:
preparing a membrane of dielectric material;
applying, in a programmed manner, a focused ion beam on the membrane to obtain a photonic crystal made up by having a regular planar arrangement of through holes positioned according to a predefined lattice, said photonic crystal further comprising a resonant cavity having a spatially confined region of the lattice inside which said through holes are absent, said resonant cavity being dimensioned to be in resonance with at least one electromagnetic radiation wavelength; and
providing a plasmonic waveguide at said resonant cavity, wherein providing the plasmonic waveguide comprises the following steps;
a) growing a projecting structure on the resonant cavity through chemical vapour deposition induced by a focused electron beam, starting from a metal-organic precursor gas;
b) depositing a noble metal layer; and
c) selectively removing the noble metal deposited outside the projecting structure by a focused ion beam;
wherein in step a) of the manufacturing of the plasmonic waveguide, the focused electron beam inducing the deposition is controlled to gradually reduce the transverse section of said electron beam starting from a first base layer of the projecting structure deposited on the membrane up to a final tip layer of the projecting structure, maintaining the position of the electron beam constant.

2. The method according to claim 1, wherein, before applying the focused ion beam to obtain the photonic crystal, the membrane is coated with a metal film by sputtering.

3. The method according to claim 1, wherein in step b) of the manufacturing of the plasmonic waveguide, a lower silver layer is deposited first, and then an upper golden layer is deposited.

4. The method according to claim 1, wherein said membrane is made by locally narrowing a cantilever of an atomic force microscope.
